(19) United States
(12) Patent Application Publication
(10) Pub. No.: US 2025/0178089 A1
(43) Pub. Date: Jun. 5, 2025

(54) COMBINATION CONTINUOUS WAVE AND PULSED LASER ADDITIVE MANUFACTURING SYSTEM AND RELATED METHODS

(71) Applicant: Blue Origin LLC, Kent, WA (US)

(72) Inventors: Kai Wing Kelvin Leung, Renton, WA (US); Chad Michael Ellison, Kent, WA (US); Kutter L. Kupke, Renton, WA (US); Ramiro Cecchet, Seattle, WA (US)

(21) Appl. No.: 18/525,264

(22) Filed: Nov. 30, 2023

(51) Int. Cl. B22F 10/366; B22F 10/25; B23K 26/06; B23K 26/0622; B33Y 10/00; B33Y 40/00

(52) U.S. Cl. CPC B22F 10/366; B22F 10/25; B23K 26/0622; B23K 26/0626; B33Y 10/00; B33Y 40/00

(57) ABSTRACT

Additive manufacturing systems and associated methods are disclosed herein. In some embodiments, the additive manufacturing system includes a build chamber that has an active build region, an energy beam system positioned to direct energy beams toward the active build area, and a controller operably coupled to the energy beam system. During an additive manufacturing process, the controller can control the energy beam system to execute a hybrid sintering process. For example, for a first region of a planned build object, the controller can operate the energy beam system in a continuous wave mode to generate a first energy beam to sinter powder in the first region. Then, for a second region, the controller can operate the energy beam system in a pulsed mode to generate a second energy beam with to sinter the second region.

### TECHNICAL FIELD

The present technology is directed generally to systems and methods for additive manufacturing, including systems and methods for manufacturing overhanging structures via an additive manufacturing system.

### BACKGROUND

Additive manufacturing, also commonly referred to as 3D printing, includes depositing layers of material to create a three-dimensional object. These techniques have found a wide variety of applications and can be used to produce objects of nearly any shape, based on data from a three-dimensional, computer-generated model.

In a typical powder bed additive manufacturing process, a thin layer of powder is spread over a build surface. A laser or other energy beam follows a computer-generated path over the powder to melt and solidify the powder only in areas corresponding to a planned build object and/or planned support structures on any given layer. Then an additional layer of powder is laid upon the first layer, and the laser again solidifies the target portions of powder. Successively sintering the powder layers melts and joins layers together to build up the planned build object. Accordingly, this process is repeated until the complete object is manufactured.

For each layer of the build, the consistency of the thickness of the new layer of powder, the quality of the underlying portions of the build object (e.g., previously sintered layers), control of the melt pool in the portions of the new layer being sintered, the quality of the powder (absence and/or presence of clumps, non-powder material, and/or other contaminants), and control of the melt pool in the portions of the new layer being sintered can each affect the quality of the new layer. For example, larger overhanging structures often overheat, resulting in surface roughness from powder that is unintentionally sintered, and/or collapsing structures. Accordingly, a typical additive manufacturing process includes building (or placing) a temporary support structure for the overhanging portion and/or smoothing outer surfaces of the overhanging portion. While the foregoing processes are suitable for producing a wide variety of objects, there remains a need for improving the process for manufacturing overhanging structures.

### BRIEF DESCRIPTION OF THE DRAWINGS

FIG. 1 is a partially schematic, partially cross-sectional view of an additive manufacturing system configured in accordance with embodiments of the present technology.

FIG. 2 is a partially schematic, partially cross-sectional plan view of a build object with an overhanging portion in accordance with embodiments of the present technology.

FIGS. 3A-3C are top views of a plan for an additive manufacturing process in accordance with embodiments of the present technology.

FIG. 4 is a partially schematic side view of a build object overlayed with a plan for an additive manufacturing process to form the build object in accordance with embodiments of the present technology.

FIG. 5A is a graph illustrating power over time for an energy beam system operating in a pulsed mode in accordance with embodiments of the present technology.

FIG. 5B is a graph illustrating power over time for an energy beam system operating in a continuous wave mode in accordance with embodiments of the present technology.

FIG. 6 is a flow diagram of a process for operating an additive manufacturing system in accordance with embodiments of the present technology.

FIGS. 7A and 7B illustrate build objects resulting from additive manufacturing processes in accordance with various embodiments of the present technology.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations are shown by way of example in the drawings and are described in detail below. The intention, however, is not to limit the technology to the particular implementations described.

### DETAILED DESCRIPTION

### Overview

Additive manufacturing systems, and associated methods, are disclosed herein. Representative additive manufacturing systems can include a build chamber having an active build area, a powder deposition system movable to spread a layer of powder over the active build area, an energy beam system positioned to direct energy beams toward the active build area, and a controller operably coupled to the energy beam system. The controller can control the additive manufacturing system to implement a hybrid process to sinter the layer of powder to form a build object. For example, for a first region of a planned build object, the controller can operate the energy beam system in a continuous wave mode to generate a first energy beam directed toward the active build area and move the first energy beam along a motion path in the active build area. The first region can be an interior and/or central region of the build object and the motion path can be based on a shape of the first region (e.g., to optimize a route through the first region). As the first energy beam impacts the layer of powder in the first region, the first energy beam sinters (e.g., heats, partially melts, welds, and/or joins) the layer to a previously deposited layer. Because the first energy beam is generated via a continuous wave mode, the first energy beam can be moved along the motion path relatively quickly.

Further, for a second region of the planned build object, the controller can operate the energy beam system in a pulsed mode to generate a second energy beam having a plurality of pulses (e.g., a burst of energy and a period of downtime) and direct the plurality of pulses of the second energy beam toward the active build area. The second region can be a peripheral and/or edge region of the build object. Each of the plurality of pulsed can be directed toward the active build area based on a planned exposure pattern for the second region of the planned build object. Each of the pulses can deliver enough energy to the powder layer targeted by the pulses to sinter the powder particles together and/or to the underlying layer of the build object. However, because each pulse also incorporates a break or off-period before more energy is delivered, the pulses can deliver a relatively low average energy (e.g., as compared to the first energy beam). As a result, and as discussed in more detail below, the second energy beam can help reduce the number of defects in the resulting build object (e.g., reduce the surface roughness of a sidewall of the build object, reduce the likelihood for the build object to warp and/or collapse, and/or the like).

In some embodiments, the planned exposure pattern for the second region includes a plurality of target spots. During the additive manufacturing process, each of the target spots will receive one or more of the pulses of the second energy beam. To help ensure that the layer of powder is fully sintered, each of the plurality of target spots can be spaced apart from the one or more adjacent (e.g., nearest other) spots by a planned distance. For example, each of the plurality of target spots can be spaced apart from adjacent spots by a distance that is less than or equal to a radius of a spot profile from each of the plurality of pulses. In some embodiments, the planned exposure pattern includes at least two lines of the target spots. While each line of the target spots may slow down the overall additive manufacturing process (e.g., as compared to sintering the powder in the line using the first energy beam), each line helps further control a melt pool of the powder adjacent to the edge, which can reduce problems caused by sintering the powder adjacent to the edge with the first energy beam.

In some embodiments, the energy beam system includes a single energy beam generator. In such embodiments, the controller can be further configured to toggle the single energy beam generator from the continuous wave mode to the pulsed mode for operation at the first region and the second region, respectively. In some embodiments, the energy beam system includes multiple energy beam generators. For example, the energy beam system can include a first energy beam generator configured to generate the first energy beam and a second energy beam generator configured to generate the second energy beam. In some such embodiments, the controller can generally simultaneously sinter the layer of powder in the first region and the layer of powder in the second region.

To form the build object, the additive manufacturing system can iteratively repeat the process discussed above. For example, after sintering the layer of powder, a recoater arm can spread a new layer of powder and the controller can control the energy beam system to sinter the new layer using the hybrid process described above. The additive manufacturing system can then repeat the process for a plurality of layers (e.g., ten layers, one hundred layers, one thousand layers, ten thousand layers, one hundred thousand layers, and/or any other suitable number of layers).

In some embodiments, one or more of the layers has a footprint that is offset, larger, and/or smaller than the layer beneath it. Additionally, or alternatively, one or more of the layers can include interior pockets that are not sintered (e.g., resulting in interior edges and/or cavities in the build object). As a result, the build object can include one or more overhanging portions (e.g., an outwardly sloped sidewall, an inwardly sloped sidewall, and/or the like). In a conventional additive manufacturing system, residual heat builds up in the build object (e.g., as a result of the continuous reception of energy from a continuous wave energy beam generator). As a result of the residual heat, the overhanging portion(s) can be at risk of warping and/or collapsing. Because even a localized warp of one or more layers can result in a defect in the build object that can undermine the structural integrity of the build object, the sidewall of the overhanging portions is typically supported by a temporary support structure. The temporary support structure can include a sacrificial column constructed adjacent to the build object during the additive manufacturing process, a column placed adjacent to the build object, and/or the like. The purpose of such structures in conventional systems is to reduce the chance the build object warps and/or collapses. Additionally, the residual heat can cause powder underlying the overhanging portions to be sintered to the build object, in turn resulting in a rough surface in the overhanging portions. The rough surface can require post-build processing to remove the excess parts and smooth the surface.

By using the second energy beam (e.g., from an energy beam generator operating in a pulsed mode (sometimes also referred to as a “pulsed laser mode”)), the additive manufacturing process can help mitigate the effects of warping, collapsing, and/or surface roughness. For example, each pulse can have a peak power that is high enough to sinter powder on contact (or after a relatively short exposure), while the break between pulses can result in an average power delivered by the second energy beam being below the average powder delivered by the first energy beam. As a result, while sintering the powder with pulses can take more time, residual heat does not build up in the target object while using the second energy beam (or does not build up as much as when using the first energy beam). Because residual heat does not build up, the risk that the build object will warp and/or collapse and/or the resulting surface roughness can be eliminated (or reduced). Accordingly, the additive manufacturing process can be conducted without forming and/or placing support structure(s) for the overhanging portions and/or without post-build processing to remove material from an exterior surface of the overhanging portions.

For ease of reference, the additive manufacturing systems, and components thereof, are sometimes described herein with reference to top and bottom, upper and lower, upwards and downwards, and/or horizontal plane, x-y plane, vertical, or z-direction relative to the spatial orientation of the embodiments shown in the figures. It is to be understood, however, that various components of the additive manufacturing systems can be moved to, and/or used in, different spatial orientations without changing the overall structure and/or function of the disclosed embodiments of the present technology. Additionally, the additive manufacturing systems, and components thereof, are sometimes described herein with reference to proximate and distal and/or the like. It is to be understood, absent an explicit description otherwise, that these terms are relative to the structures and/or pathways being discussed. For example, powder distribution channels and/or components thereof are sometimes discussed as proximate to the blades, and the proximate positioning is relative to the movement of powder in the additive manufacturing system.

### DESCRIPTION OF THE FIGURES

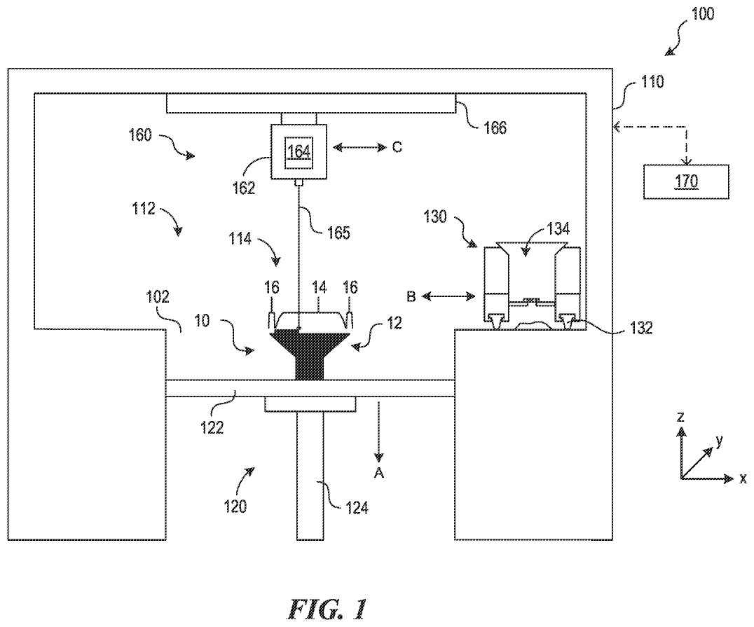

FIG. 1 is a partially schematic, partially cross-sectional view of an additive manufacturing system 100 configured in accordance with representative embodiments of the present technology. As illustrated, the additive manufacturing system 100 (“system 100”) can include a build chamber 110 (shown in cross-section). The build chamber 110 includes a central portion 112 with an active build region 114. The system 100 also includes a support system 120, a recoater arm 130, and an energy beam system 160, each of which can be operably coupled to a controller 170.

In the illustrated embodiment, the support system 120 includes a support platform 122 and a first actuator 124 operably coupled to the support platform 122. The support platform 122 (e.g., a plate or other suitable support structure, sometimes also referred to herein as a “build platform”) extends across at least a portion of (or all of) the central portion 112 to support and help position powder 102 and a build object 10 in the active build region 114. The first actuator 124 is operably coupled to the support platform 122 to move the support platform 122 (and anything thereon) in an upward and downward direction along a first motion path A (e.g., along a z-axis). The recoater arm 130 includes one or more blades 132 (two shown in the illustrated embodiment) and a powder deposition system 134 (sometimes also referred to herein as a “powder dispensing component,” an “onboard powder storage component,” and/or a “powder source”).

During an additive manufacturing process (sometimes referred to herein as a “build process” and/or a “build”), the first actuator 124 can move the support platform 122 downward to make room for a new layer of the powder 102 to be deposited over the active build region 114. The powder can include a metallic powder, such as titanium-based powders, steel-based powders, stainless steel-based powders, aluminum-based powders, copper-based powders, nickel-based powders, and the like; various suitable ceramic powders; glass composites; and/or any other suitable material. After the support platform 122 moves downward, the powder deposition system 134 can deposit a volume of new powder. Next, the recoater arm 130 can move in a lateral direction along a second motion path B (e.g., along the x-axis) over the support platform 122. As the recoater arm 130 moves, the blade(s) 132 spread the volume of the powder 102 in a thin, generally uniform layer over the active build region 114.

In some embodiments, spreading the new layer requires a trip back and forth along the second motion path B (e.g., from right to left in the illustrated orientation, then from left to right). In various embodiments, the system 100 can include a powder recycling system and/or a powder disposal system positioned peripheral (or partially peripheral) to the central portion 112 to help manage excess powder at either end of the second motion path B. Purely by way of example, the system 100 can include a powder recycling system of the type disclosed in U.S. patent application Ser. No. 18/490,580 by Steve Craigen filed on October 19, the entirety of which is incorporated herein by reference.

In some embodiments, the first actuator 124 moves the support platform 122 downward between the forward and backward motions of the recoater arm 130. In such embodiments, for example, the forward motion over the active build region 114 can spread a first portion of a powder layer, while the backward motion from the active build region 114 can spread the second portion of the powder layer. In other embodiments, the support platform 122 does not move between the forward and backward motion. In such embodiments, both motions can help to spread the entire powder layer over the active build region 114.

After the powder layer has been fully deposited and spread over the active build region 114, the energy beam system 160 can sinter the powder 102 in a controlled, planned pattern to form the build object 10. In the illustrated embodiment, the energy beam system 160 includes an energy beam head 162 carrying one or more energy beam sources 164 (one is shown in FIG. 1) and a track 166. The energy beam source(s) 164 directs one or more energy beams 165 toward the active build region 114 to sinter the powder 102 in the newly deposited layer onto the build object 10 based on the planned pattern. The track 166 allows the energy beam head 162 to move in a lateral direction along a third motion path C. Further, the track 166 itself can move along a y-axis (transverse to the plane of FIG. 1 and perpendicular to the z and x-axes) to cover the active build region 114.

In turn, the energy beam head 162 can use the movement to target appropriate regions of the active build region 114. For example, in the illustrated embodiment, the build object includes an overhanging portion 12 (e.g., a portion that includes one or more surfaces that are not directly supported along the z-axis). The planned pattern includes a first region 14 and a second region 16 positioned outwardly from, or peripheral to, the first region 14. As discussed in more detail below, the energy beam source(s) 164 can operate in a first mode (e.g., a continuous wave mode) while sintering the powder 102 in the first region 14 and a second mode (e.g., a pulsed mode) while sintering the powder 102 in the second region 16. The first mode can allow the energy beam system 160 to more quickly (e.g., compared to the second mode) sinter the powder 102 in the first region 14. As a result, the energy beam system 160 can quickly sinter the powder 102 in the central portion of the current layer. The second mode can better control the melt pool (e.g., compared to the first mode) while sintering the powder 102 in the second region 16. As a result, the energy beam system 160 can reduce the amount of overheating experienced by peripheral portions of the build object 10, thereby reducing the roughness of resulting surfaces and/or reducing the number of failures in the overhanging portion 12.

In addition to, or as an alternative to, the track 166, the energy beam head 162 can include one or more reflectors operably coupled to one or more servo motors to direct the energy beam(s) 165 toward the active build region 114. In some such embodiments, the energy beam head 162 can remain in a single location throughout the build while directing the energy beam(s) 165 toward the active build region 114.

After the energy beam system 160 sinters the powder 102 in the active build region 114, the build process can repeat the steps above: e.g., by to moving the support platform 122 downward, spreading a new layer of the powder 102 over the active build region 114, and sintering the new layer. These steps can be repeated any number of times until the build object 10 is complete. After the build object 10 is completed, a user can remove the build object 10, any unused powder (e.g., non-sintered powder) can be recovered, and the first actuator 124 can move the support platform 122 upward to reset the support system 120 for the next build.

As discussed above, the controller 170 can be coupled to each of the components of the system 100. The controller 170 (shown schematically) can be programmed with instructions for directing the operations and motions carried out by the support system 120, the recoater arm 130, the energy beam system 160, and/or any other suitable components of the system 100 described herein. Accordingly, the controller 170 can include a processor, memory, and input/output devices, any of which can include a computer-readable medium containing instructions for operating the system 100. The instructions can be executed by the controller 170 to perform some or all of the tasks described herein. In some embodiments, the controller 170 is configured to receive a computer-generated model of the build object 10 and to control the operations and motions of the components of the system 100 to manufacture the build object 10 based on the computer-generated model. In some embodiments, the controller 170 is configured to receive feedback information about the additive manufacturing process from, for example, various sensors, cameras, and the like that can be located within the chamber 110. The controller 170 can also be configured to modify/direct operations and motions of the various components of the system 100 based at least in part on the received feedback information.

For example, information from sensors can indicate that the recoater arm 130 is depositing and spreading an amount of the powder 102 that is insufficient to fully cover the central portion 112. Insufficient coverage can result in a shortfill in a future powder layer if the insufficiency is not addressed. In this example, the controller 170 can be configured to receive the information and control the powder deposition system 134 to deposit larger volumes of powder in the following layers, thereby avoiding a future shortfill. In another example, the sensors can measure the temperature of the powder 102 to help monitor the melt pool of the powder 102 while forming the build object 10. In this example, the controller 170 can be configured to receive information related to the temperature and control the energy beam system 160 to account for the melt pool. In a specific, non-limiting example, the measured temperatures can indicate that the melt pool is larger than necessary to sinter the powder in the second region 16. In this example, the controller 170 can be configured to reduce an energy output from the energy beam system 160 and/or disperse the energy output over a longer period (e.g., reducing a maximum power of energy pulses, reducing a duty cycle of the pulses, increasing an overall pulse period, and/or the like). By reducing the energy output and/or dispersing the energy output, the energy beam system 160 can help control the melt pool. As a result, the energy beam system 160 can reduce the surface roughness for the overhanging portion 12 and/or help avoid overheating that can cause the overhanging portion 12 to collapse.

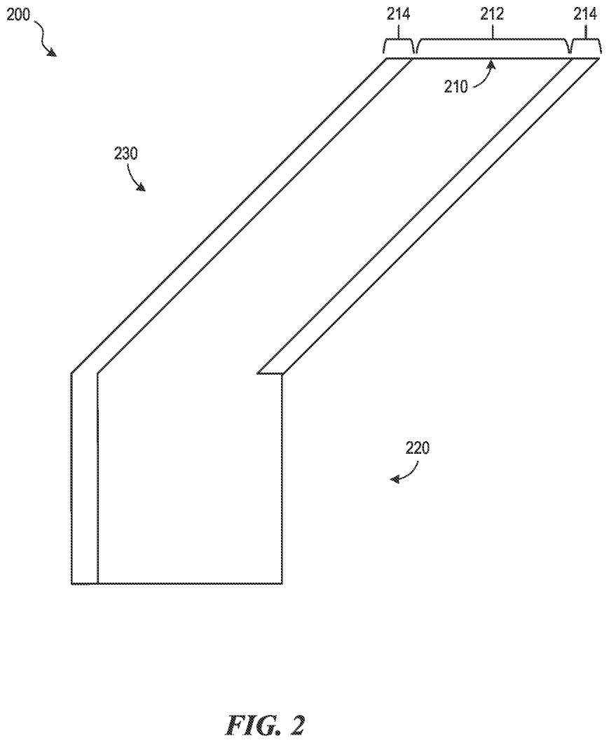

FIG. 2 is a partially schematic, partially cross-sectional plan view of a build object 200 resulting from an additive manufacturing process in accordance with some embodiments of the present technology. The build object illustrated in FIG. 2 has an upper surface 210, a vertical portion 220, and an overhanging portion 230. The build object 200 can be created layer-by-layer through an additive manufacturing process. As discussed above, the additive manufacturing process can include repeatedly spreading a new layer of powder over existing portions of the build object 200 (or over a support platform, for the first layer) and sintering the new layer of the powder to the upper surface 210 of the build object 200 based on a plan for the build object 200.

As further discussed above, the additive manufacturing process can operate an energy beam system (e.g., having one or more laser beam generators) in a continuous wave mode and a pulsed mode while sintering the new layer of the powder to the upper surface 210. For example, as illustrated schematically in FIG. 2, the upper surface 210 can include a first portion 212 and a second portion 214. The second portion 214 (sometimes also referred to herein as a “peripheral portion,” an “outer portion,” a “perimeter,” an “edge portion,” an “overhanging portion,” and/or the like) can be peripheral to, or laterally outward from, the first portion 212 (sometimes also referred to herein as a “central portion,” a “supported portion,” and/or the like) with respect to a center of the upper surface 210. In various embodiments, for example, the second portion 214 forms a perimeter around a portion of, or all of, the first portion 212 (sometimes also referred to herein as an “interior portion,” a “central portion,” and/or the like. Additionally, or alternatively, the second portion 214 can be closer to one or more interior edges of the upper surface 210 than the first portion 212. In some embodiments, for example, the build object 200 includes one or more interior cavities. As a result, the upper surface 210 can include interior edges that are lined by the second portion 214.

As discussed above, the additive manufacturing process can use different energy beam modes while forming the build object 200. More specifically, the additive manufacturing process can operate a first energy beam generator (e.g., the energy beam source 164 of FIG. 1) in continuous wave mode while targeting the first portion 212 and can operate the first energy beam generator (or a second energy beam generator) in a pulsed mode while targeting the second portion 214. The additive manufacturing process can use the continuous wave mode to quickly sinter a new layer of powder in the first portion 212 of the upper surface 210 to the build object 200. However, the continuous wave mode can result in a large melt pool in the new layer that can cause surface roughness if targeted at the edges of the build object 200, especially for the overhanging portion 230 of the build object 200. Additionally, the large melt pool associated with the continuous wave mode can cause the overhanging portion 230 of the build object 200 to warp and/or collapse (e.g., as heat spreads to previously sintered layers). In contrast, the additive manufacturing process can use the pulsed laser mode to help control the melt pool while sintering the new layer of powder in the second portion 214 to the build object 200. The increased control can reduce (or eliminate) the surface roughness in the build object 200, especially for the overhanging portion 230 of the build object 200. Additionally, by controlling the melt pool, the additive manufacturing process can reduce (or eliminate) the chance that the overhanging portion 230 of the build object 200 will warp and/or collapse. However, the pulsed mode can take more time to sinter the second portion 214 of the upper surface 210 and/or can require a relatively complex (e.g., as compared to building with the continuous wave mode) pattern for targeting the second portion 214.

The additive manufacturing process can use various combinations of the continuous wave and pulsed laser modes while targeting the first and second portions 212, 214 of the upper surface 210 based on which portion of the build object 200 is being formed. For example, the concerns associated with the continuous wave mode (e.g., regarding the surface roughness (or an unacceptable amount of surface roughness) and/or collapse from overheating) are reduced (or absent) while forming the vertical portion 220 of the build object 200. Accordingly, in some embodiments, the additive manufacturing process uses the continuous wave mode for both the first and second portions 212, 214 while forming the vertical portion 220 of the build object 200, then switches to the hybrid process described above for the overhanging portion 230. This workflow allows the additive manufacturing process to use a quicker sintering from the continuous wave mode while the associated concerns are low, then use the hybrid process when the concerns are elevated. Alternatively, the additive manufacturing process can use the pulsed mode for only a sub-section of the second portion 214 while forming the vertical portion 220. For example, in the illustrated embodiment, the additive manufacturing process used the pulsed mode for only the left section of the second portion 214 while forming the vertical portion 220. In such embodiments, the workflow allows the additive manufacturing process to use the quicker sintering from the continuous wave mode for a larger percentage of the build object 200 while the associated concerns are low, but use the pulsed mode for fine control of an important surface (e.g., an interior surface when the build object is completed and/or otherwise inaccessible for post-build processing to smooth the surface).

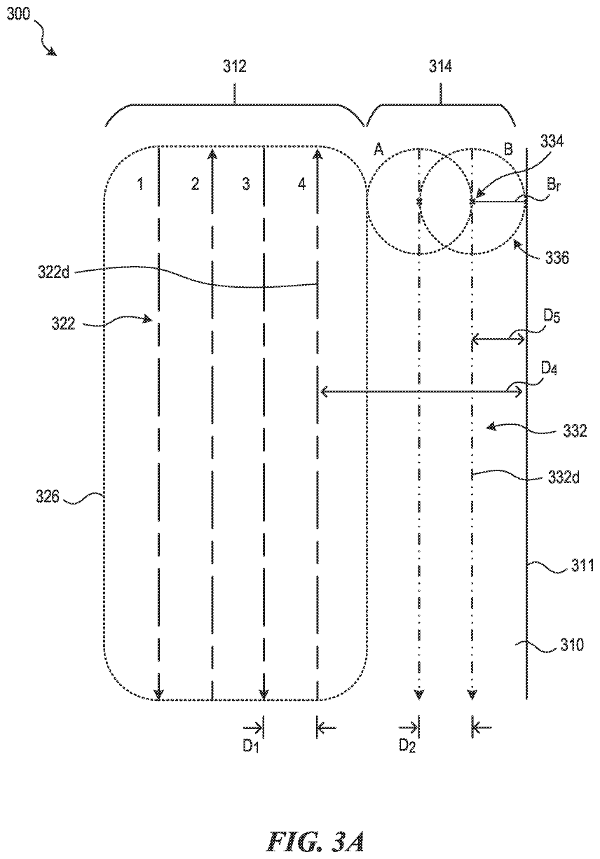

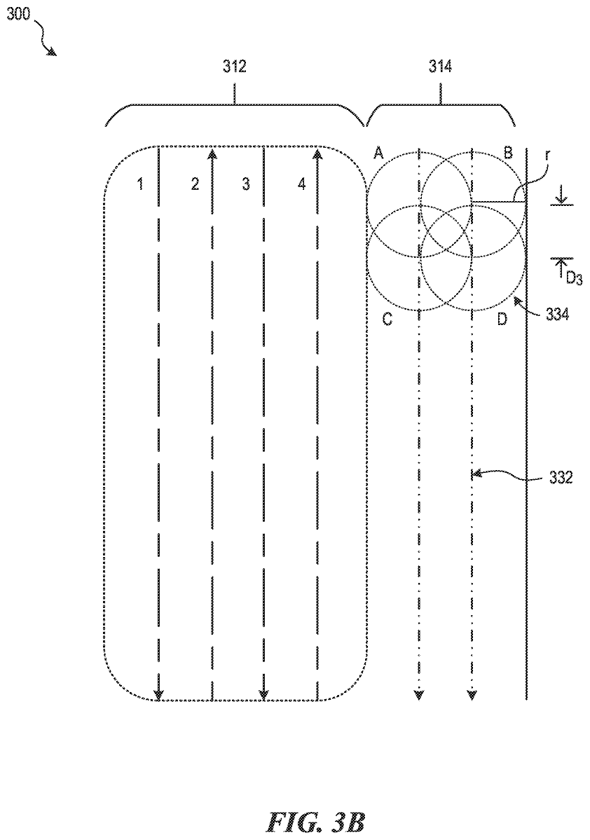

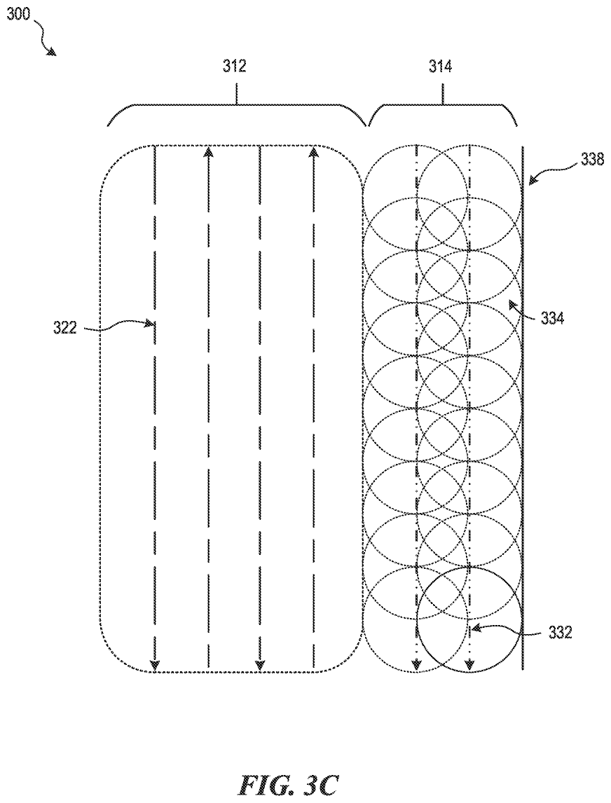

FIGS. 3A-3C are top views of a portion of a plan 300 for an additive manufacturing process in accordance with some embodiments of the present technology. As illustrated in FIG. 3A, the plan 300 can be implemented by the additive manufacturing process to sinter powder over an upper surface 310 of a build object adjacent to an edge 311 of the build object. As a result, the plan 300 can help improve a surface roughness at the edge 311 and/or reduce the likelihood for the build object to warp and/or collapse (e.g., when the plan 300 is implemented for an overhanging portion of the build object).

As further illustrated in FIG. 3A, the plan 300 can include one or more first contour lines 322 (four illustrated in FIG. 3A) in a first region 312 of the upper surface 310 and one or more second contour lines 332 (two illustrated in FIG. 3A) in a second region 314 of the upper surface 310. The first region 312 can correspond to a central and/or interior region of the upper surface 310 (e.g., farther from the edge 311 than the second region 314) while the second region 314 can correspond to a peripheral and/or exterior region of the upper surface 310 (e.g., closer to the edge 311 than the first region 312). Based on the plan 300, an additive manufacturing system (e.g., under the control of the controller 170 of FIG. 1) can operate an energy beam system (e.g., the energy beam system 160 of FIG. 1) to generate a first energy beam and sequentially trace the first contour lines 322 (e.g., in the order indicated by numerals 1, 2, 3, and 4 and/or any other suitable order). More specifically, the additive manufacturing system can operate the energy beam system in a continuous wave mode to generate an energy beam with a constant (or nearly constant) power output. The constant power output can be sufficient to sinter the powder in an exposure area 326 targeted by the energy beam to the first region 312 of the upper surface 310. For example, the first energy beam can have a constant power output of between about 100 Watts (W) and about 1000 W, between about 200 W and about 800 W, or of about 300 W. However, because the energy beam is constantly delivered to the powder above the first region 312 of the upper surface 310, residual heat is transferred to surrounding areas, resulting in a larger melt pool for the first energy beam than the spot size of the first energy beam. As used herein, the continuous wave mode refers to an operation mode that generates an energy beam with a constant, or generally constant, average power output as well as a functionally equivalent pulsed beam.

The additive manufacturing system can then switch the energy beam system to a pulsed mode (e.g., by altering an operating mode of a single energy beam generator and/or operating a second energy beam generator in the system) to generate a second energy beam that includes a plurality of pulses. One or more of the plurality of pulses can then be directed to target locations 334 along the second contour lines 332. Each of the pulses can have an exposure area 336 generally centered around a corresponding one of the target locations 334 (sometimes also referred to herein as “target areas”). The peak power can be sufficient to sinter the powder in the exposure area 336 for each of the target locations 334 to the second region 314 of the upper surface 310. In various embodiments, each of the pulses can have a peak power between about 50 and about 400 W, between about 150 W and about 250 W, or of about 200 W. Further, each of the pulses can have a pulse width between about 3.2 milliseconds (ms) (i.e., 3200 microseconds (μs)) and about 6.4 ms, a pulse period between about 12.8 ms and about 25.6 ms, and a duty cycle (e.g., the fraction or percentage of a pulse period the energy beam is active) of between about 10 percent and about 40 percent, between about 20 percent and about 30 percent, or of about 25 percent. In some such embodiments, while the peak power is sufficient to sinter the power within the exposure area 336 (e.g., the spot size), the average power (e.g., peak power multiplied by the duty cycle) can be sufficiently low that the heat transferred to neighboring areas is insufficient to sinter (or otherwise melt) the powder adjacent to the target object and/or previously sintered material. As a result, the plan 300 is able to control the melt pool of the second energy beam to only the exposure area 336 at each of the target locations 334.

As illustrated in FIG. 3B, the plan can direct one or more pulses toward the target locations 334 targeted sequentially (e.g., targeting areas A, then B, then C, then D, and so on) moving between the two second contour lines 332. As illustrated in FIG. 3C, the sequential addressing process can continue until each of the plurality of target locations 334 has been addressed, resulting in an overall exposure area 338 from the second energy beam that generally covers the powder in the second region 314 of the upper surface 310. In some embodiments, the target locations 334 are targeted sequentially while moving along a first one of the second contour lines 332, then along a second one of the second contour lines 332.

Returning to FIG. 3A, each of the first and second contour lines 322, 332 of the plan 300 can be positioned to help ensure that the powder over the upper surface 310 is adequately exposed. For example, in the illustrated embodiment, each of the first contour lines 322 is spaced apart by a first distance D₁, each of the second contour lines 332 is spaced apart by a second distance D₂. The first distance D₁ can be equal to or less than a width of the spot size (e.g., the diameter when the spot size is a circle), thereby creating overlap between the spot size as the first energy beam scans the contour lines 322. The overlap, in turn, ensures that there are no gaps in the exposure area 326 and that all of the powder above the first region 312 of the upper surface 310 is sintered. Similarly, the second distance D₂ can be equal to or less than a width of the spot size of the second energy beam, thereby creating overlap between the exposure areas 336 at each of the target locations 334. Unlike the overlap between the exposure area 326 for the first contour lines 322, the overlap between the exposure areas 336 for the second contour lines 332 also impacts the number of target locations 334 that are necessary to fully sinter the powder above the second region 314 of the upper surface 310. When the overlap is increased (e.g., D₂ is decreased), a third distance D3 (FIG. 3B) between adjacent target locations 334 on the second contour lines 332 can be increased, resulting in less overlap between the adjacent target locations 334 along a single one of the second contour lines 332. However, the increased overlap can result in more of the second contour lines 322 being necessary to fully sinter the powder above the second region 314 of the upper surface 310. In the embodiment illustrated in FIGS. 3A and 3B, the second and third distances D₂, D₃ are generally equal to half of the spot size of the second energy beam (e.g., generally equal to the radius R of the exposure areas 336), thereby equally dispersing the target locations 334 throughout the second region 314.

As further illustrated in FIG. 3A, a peripheral-most first contour line 322d can be a fourth distance D4 from the edge 311 of the upper surface 310 while a peripheral-most second contour line 332d can be a fifth distance D₅ from the edge 311. The fifth distance D₅ is generally equal to the radius R of the exposure areas (and the spot area of the second energy beam) such that the second energy beam sinters powder all the way to the edge 311. The fourth distance D₄, minus the radius of the spot area of the first energy beam, defines the transition between the first energy beam and the second energy beam (e.g., the transition between the continuous wave mode and the pulsed mode). Accordingly, the fourth distance D₄ can be set based on the number of the second contour lines 332 that are desirable for the plan 300 to reduce (or minimize) the negative effects of the continuous wave mode on the surface of the build object at the edge 311. In various embodiments, the fourth distance D₄ can be set to provide room for one, two, three, five, ten, and/or any other suitable number of the second contour lines 322.

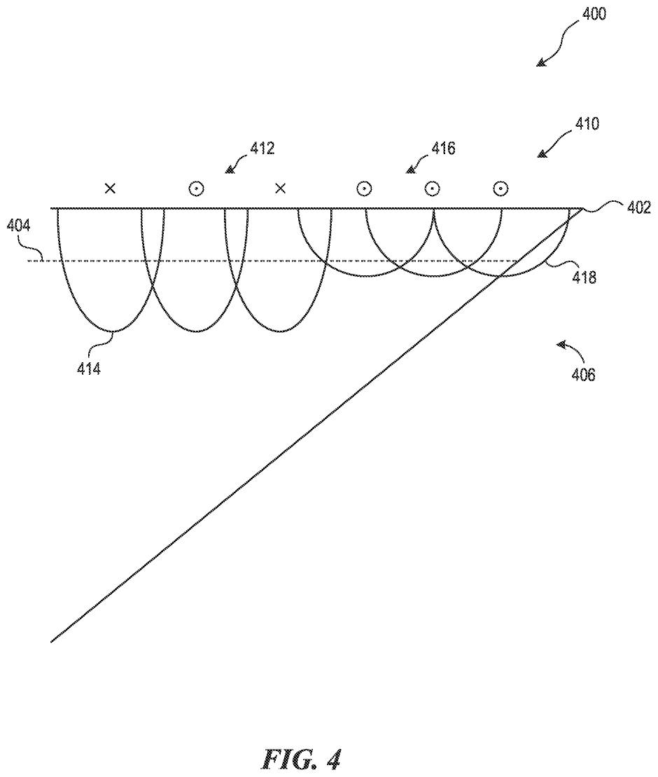

FIG. 4 is a partially schematic side view of a build object 400 overlayed with a plan 410 for an additive manufacturing process to form the build object 400 in accordance with some embodiments of the present technology. In the illustrated embodiment, the plan 410 is generally similar to the plan 300 discussed above with reference to FIGS. 3A-3C. For example, the plan 410 includes one or more first contour lines 412 (three illustrated in FIG. 4) and one or more second contour lines 416 (two illustrated in FIG. 4). Further, the first and second contour lines 412, 416 can be traced by an energy beam system to sinter a new layer 404 to the build object 400.

For example, as schematically illustrated in FIG. 4, the additive manufacturing process (e.g., under the control of the controller 170 of FIG. 1) can operate an energy beam system (e.g., the energy beam system 160 of FIG. 1) in a continuous wave mode while targeting the first contour lines 412, resulting in a first melt pool 414 along the first contour lines 412. Within the first melt pool 414, powder in the new layer 404 is sintered and/or otherwise joined to the build object 400. Similarly, the additive manufacturing process can then operate the energy beam system in a pulsed mode while targeting the second contour lines 416, resulting in a second melt pool 418 along the second contour lines 416. Within the second melt pool 418, powder in the new layer 404 is sintered and/or otherwise joined to the build object 400.

In the pulsed mode, the energy beam system can deliver energy pulses that have a peak energy high enough to sinter powder in the new layer on contact (or with a relatively short exposure period). However, in the pulsed mode, the duty cycle can be low enough to reduce the amount of residual heat in the new layer 404 and/or the build object 400. As a result, as further schematically illustrated in FIG. 4, the second melt pool 418 can have a more restrained profile (and/or a shallow profile) than the first melt pool 414. The more restrained profile of the second melt pool 418 can reduce the amount of residual heat in the build object 400 while sintering powder close to an edge 402 of the build object. In turn, the reduction in residual heat can reduce the amount of powder that is unintentionally sintered to the build object 400 resulting in surface roughness on the edge 402. Additionally, or alternatively, the reduction in residual heat can reduce the risk of an overhanging portion 406 of the build object warping and/or collapsing.

Each of these reductions can improve the quality of the build object 400 resulting from the manufacturing process. Additionally, or alternatively, while operating the energy beam system in a pulsed mode can take more time than operating the energy beam system in the continuous wave mode, the additive manufacturing process can omit steps that would be required if the continuous wave mode was used to manufacture the entire build object 400. For example, because operating the energy beam system in the pulsed mode based on the plan 410 reduces the risk of collapsing and/or warping in the build object 400, the additive manufacturing can omit steps that would otherwise be used to form and remove (or place and remove) support structures for the overhanging portion 406. In another example, because operating the energy beam system in the pulsed mode based on the plan 410 improves the surface roughness near the edge 402, the additive manufacturing process can reduce (or eliminate) the amount of post-processing that is required on the edge 402. In each example, omitting the additional steps can accelerate the additive manufacturing process and/or reduce the costs of forming the build object 400.

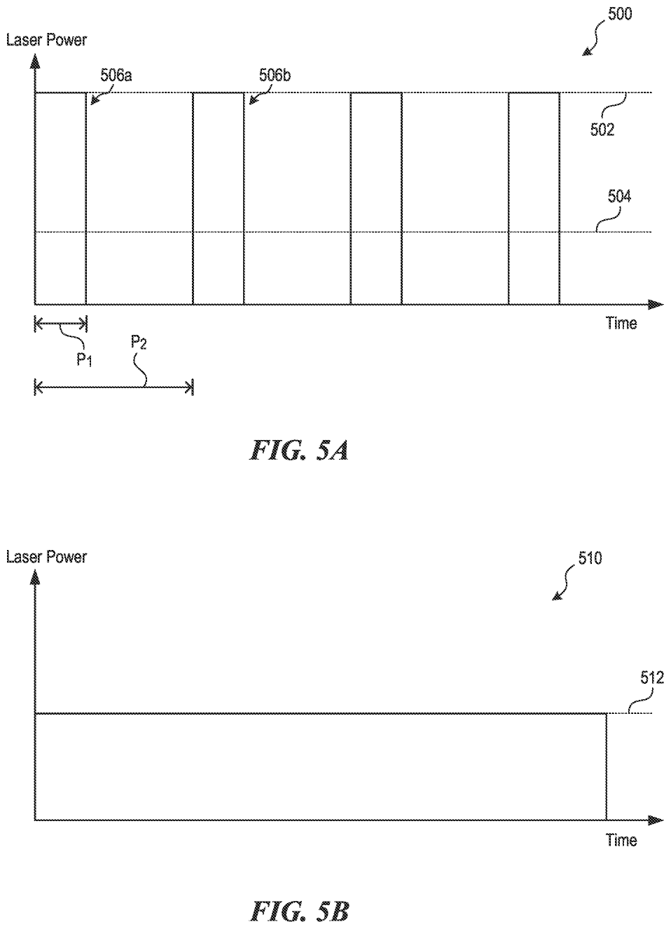

FIG. 5A is a graph 500 illustrating power as a function of time for an energy beam system operating in a pulsed mode. As illustrated the pulsed mode (sometimes also referred to as a “pulsed laser mode”) emits bursts of energy spaced out over time (which are sometimes referred to as energy pulses and/or light flashes). Each burst of energy has a pulse width P₁ (sometimes also referred to as a pulse duration) and a peak power 502. Further, the bursts of energy are spaced out over time, such that the energy beam system does not emit energy for a length of time between each burst. The total time between the start of a first burst of energy 506a and a second burst of energy 506b is referred to as a pulse period P2, while the ratio of the pulse width P₁ over the pulse period P2 is referred to as the duty cycle of the energy beam system. Because no energy is emitted between the bursts, the energy beam system has an average power 504 that is a fraction of the peak power 502. More specifically, the average power 504 is equal to the peak power 502 multiplied by the duty cycle.

To use the pulsed mode, an additive manufacturing system (e.g., under the control of a controller such as the controller 170 of FIG. 1) can set the peak power 502 high enough that any powder an energy burst is incident on is fully or partially sintered during the pulse width P₁, allowing one or more energy bursts to deliver enough powder to sinter a new layer. However, the additive manufacturing system can set the duty cycle (e.g., by adjusting the pulse width P₁ and/or the pulse period P2) to set the average power 504 low enough to avoid the detrimental effects of residual heat. For example, the additive manufacturing system can set the average power 504 below a threshold that maintains and/or builds heat in the powder, thereby reducing the chance that additional powder is sintered (e.g., resulting in a rough surface) and/or the chance that the build object collapses and/or warps.

In various embodiments, the peak power 502 can be set between 50 W and about 400 W, or between about 150 W and about 250 W, or of about 200; the pulse width P₁ can be between about 0.4 ms and about 25.6 ms, or between about 3.2 ms and about 6.4 ms; the pulse period can be between about 0.8 ms and about 51.2 ms, or between about 12.8 ms and about 25.6 ms; and the duty cycle can be between about 10 percent and about 40 percent, between about 20 percent and about 30 percent, or of about 25 percent.

In the illustrated embodiment, the energy beam system has a square profile for each of the bursts of energy (e.g., the instantaneous power is generally equal to the peak power 502 throughout the pulse width P₁). However, it will be understood that each of the pulses can have a ramp up and ramp down within the pulse width P₁ (e.g., with a bell-curve profile).

FIG. 5B is a graph 510 illustrating power over time for an energy beam system operating in a continuous wave mode. As illustrated in FIG. 5B, the continuous wave mode provides a constant emission of power. As a result, the peak power is equal to (or generally equal to) the average power 512. Because the energy beam system is always actively emitting energy there is no pulse width, pulse period, or duty cycle for the continuous wave mode. Although FIG. 5B illustrates a literal continuous wave mode with a stable emission of power, it will be understood that the continuous wave mode is not so limited. For example, the continuous wave mode can have a constant emission that fluctuates within 10% of the average power 512 (e.g., based on imperfections in operation of the energy beam system). In another example, as discussed above, the continuous wave mode can generate a pulsed laser that is functionally equivalent to the continuous wave output illustrated in FIG. 5B.

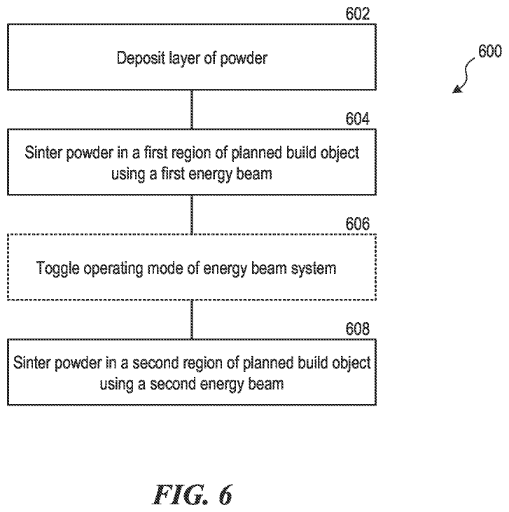

FIG. 6 is a flow diagram of a process 600 for operating an additive manufacturing system in accordance with further embodiments of the present technology. The process 600 can be implemented by the controller 170 of FIG. 1 to control various components of the system 100. It will be understood that the process 600 can be repeated any suitable number of times during a relevant build process to construct ab build object.

The process 600 begins at block 602 with depositing a layer of powder over an active build region of a build chamber. As discussed above with reference to FIG. 1, depositing the layer of powder can include dispensing a volume of powder in front of a recoater arm, then moving the recoater arm over the active build region to spread the volume of powder into the layer. In some embodiments, spreading the layer of powder includes moving the recoater arm forward and backward over the active build region one or more times.

At block 604, the process 600 includes sintering (and/or otherwise melting and/or affixing) powder in a first region of a planned build object using a first energy beam. The first region can be a central and/or interior portion of the planned build object (e.g., areas where resulting surface roughness and/or overhanging edges are not at risk). Accordingly, the first energy beam can be output from an energy beam system operating in a continuous wave mode to allow the process 600 to quickly sinter the powder in the first region.

At optional block 606, the process 600 includes toggling (or otherwise changing) the operating mode of the energy beam system between a first mode (e.g., the continuous wave mode) and a second mode (e.g., a pulsed laser mode). In some embodiments, the energy beam system includes a single energy beam generator (e.g., a single laser generator). In some such embodiments, toggling the mode of the energy beam system includes toggling the mode of the single energy beam generator to change the resulting energy beam. In some embodiments, the energy beam system includes multiple energy beam generators. In some such embodiments, a first energy beam generator can be dedicated to operating in the continuous wave mode while a second energy beam generator is dedicated to operating in the pulsed laser mode. In such embodiments, toggling the operating mode of the energy beam system includes activating/deactivating the first and second energy beam generators.

At block 608, the process 600 includes sintering (and/or otherwise melting and/or affixing) powder in a second region of the planned build object using a second energy beam. The second region can be a peripheral and/or edge portion of the planned build object. Accordingly, the second energy beam can be output from an energy beam system operating in a pulsed wave mode to allow the process 600 to reduce the resulting surface roughness on edges of the build object and/or reduce the risk the planned build object collapses and/or warps.

In some embodiments, the process 600 implements blocks 604 and 608 in an inverse order to sinter the peripheral and/or edge portions of the planned build object before sintering the central and/or interior portions. Additionally, or alternatively, in embodiments that have multiple energy beam generators, the process 600 can implement blocks 604 and 608 at generally the same time (e.g., directing the first energy beam toward the first region while directing the second energy beam toward the second region) and omit optional block 606.

After sintering the powder in the second region at block 608, the process 600 includes lowering a support surface (e.g., lowering the support platform 122 of FIG. 1) and returning to block 602 to deposit the next layer of powder. By lowering the support surface, the process 600 provides room for the next layer of powder to be spread over the active build region (e.g., covering the previous new layer and the portions of the build object resulting from blocks 604-608) without needing to raise the recoater arm. Further, by lowering the support surface to maintain each new layer at the same (or generally the same) elevation, the process 600 can repeat blocks 602-608 without needing to adjust the energy beam system for a changing depth of the target.

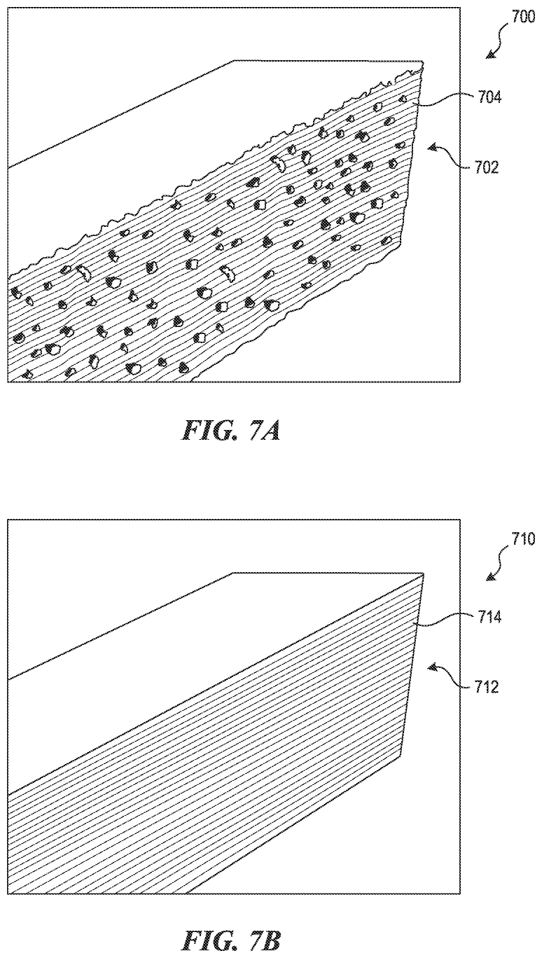

FIGS. 7A and 7B illustrate build objects resulting from different additive build processes. More specifically, FIG. 7A illustrates a build object 700 resulting from an additive manufacturing process that uses a continuous wave laser to sinter the entirety of each of the layers 702 in the build object 700. As a result, as illustrated in FIG. 7A, an external surface 704 the build object 700 can have a relatively high surface roughness (e.g., where additional powder is unintentionally sintered to the external surface 704). The resulting surface roughness can be especially high when the external surface 704 is a down-facing surface (e.g., where the build object 700 has an overhanging portion). Additionally, or alternatively, as further illustrated in FIG. 7A, the sintering process using only a continuous wave laser can result in warping between each of the layers 702.

In contrast, FIG. 7B illustrates a build object 710 resulting from an additive manufacturing process that uses a hybrid sintering process like the process 600 discussed above with reference to FIG. 6. Because the process better controls the melt pool around edges and/or peripheral regions, as illustrated in FIG. 7B, the build object 710 has less warping between each of the layers 712 than the build object 700 illustrated in FIG. 7A, or may produce no warping at all. Additionally, as further illustrated in FIG. 7B, an external surface 714 of the build object 710 can have a relatively smooth surface roughness (e.g., as compared to the build object 700 illustrated in FIG. 7A). As a result, the build object 710 illustrated in FIG. 7B can require little (or no) post-build processing to smooth the external surface 714 and/or remove unintended additions.

### EXAMPLES

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples can be combined in any suitable manner, and placed into a respective independent example. The other examples can be presented in a similar manner.
1. A method for operating an additive manufacturing system to form a build object, the method comprising:
for a first region of a build object, operating an energy beam system in a continuous wave mode to:
   generate a first energy beam; and
   scan the first energy beam along a motion path in the first region to sinter powder in the first region to a previous layer of the build object; and
for a second region of the build object closer to an edge of the build object than the first region of the build object, operating the energy beam system in a pulsed mode to:
   generate a second energy beam; and
   direct pulses of the second energy beam toward the second region to sinter powder in the second region to a previous layer of the build object based on a planned exposure pattern.
2. The method of clause 1 wherein the planned exposure pattern includes a plurality of target spots positioned to receive one or more of the pulses of the second energy beam, and wherein an individual of target spot is spaced apart from one or more nearest target spots by a planned distance.
3. The method of clause 2 wherein the second energy beam has a spot profile when incident on the powder in the second region, and wherein the planned distance is less than or equal to a radius of the spot profile.
4. The method of any of clauses 1-3 wherein the planned exposure pattern includes a plurality of target spots positioned to receive one or more of the pulses of the second energy beam and distributed to expose all of the powder in the second region to at least one pulse of the second energy beam.
5. The method of any of clauses 1-4 wherein the planned exposure pattern includes at least two lines of a plurality of target spots for the pulses of the second energy beam.
6. The method of any of clauses 1-5 wherein the energy beam system includes a single energy beam generator, and wherein the method further comprises toggling the single energy beam generator from the continuous wave mode to the pulsed mode between operating on the first region and the operating on second region.
7. The method of any of clauses 1-6 wherein, in the pulsed mode, the second energy beam has a pulse period between 12.8 milliseconds (ms) and 25.6 ms and a pulse width between 3.2 ms and 6.4 ms.
8. The method of any of clauses 1-7 wherein the build object includes a plurality of layers, wherein the first region and the second region are on individual one of the plurality of layers, and wherein the method further comprises, for each other individual layer in the plurality of layers:
for a central region of the other individual layer, operating the energy beam system in the continuous wave mode to sinter powder in the central region; and
for a peripheral region of the other individual layer, operating the energy beam system in the pulsed mode to sinter powder in the peripheral region,
wherein each layer in the plurality of layers has a footprint that is at least partially offset from a previous layer to form an overhanging portion of the build object.
9. The method of clause 8 wherein each layer in the plurality of layers is sintered without forming a support structure to support the overhanging portion or removing material from an exterior surface of the overhanging portion after sintering the plurality of layers.
10. The method of any of clauses 1-5 and 7-9 wherein the energy beam system includes a first energy beam generator configured to generate the first energy beam and a second energy beam generator configured to generate the second energy beam.
11. A method for operating an additive manufacturing system to form an overhanging portion of a build object, the method comprising:
depositing a layer of powder over an active build area within a build chamber of the additive manufacturing system;
sintering a first region of a target area of the layer of powder to a previous layer of the build object, wherein sintering the first region of the target area includes:
   operating an energy beam system in a continuous wave mode to generate a first energy beam having a continuous output; and
   directing the first energy beam along one or more scan lines in the first region; and
sintering a second region of the target area to the previous layer of the build object, wherein the second region of the target area is closer to an edge of the overhanging portion than the first region, and wherein sintering the second region of the target area includes:
   operating the energy beam system in a pulsed mode to generate a second energy beam having a plurality of pulses; and
   directing the second energy beam along a contour line in the second region to deliver one or more of the plurality of pulses to each of a plurality of target locations along the contour line.
12. The method of clause 11 wherein the layer of powder is a first layer of powder, wherein the target area is a first target area, wherein the one or more scan lines are one or more first scan lines, wherein the contour line is a first contour line, and wherein the method further comprises:
depositing a second layer of powder over the active build area of the build chamber;
sintering a first region of a second target area of the second layer of powder to a sintered portion of the first layer of powder, wherein the first region of the second target area is at least partially laterally offset from the first region of the first target area to form the overhanging portion, and wherein sintering the first region of the second target area includes:
   operating the energy beam system in the continuous wave mode to generate the first energy beam; and
   directing the first energy beam along one or more second scan lines in the first region of the second target area; and
sintering a second region of the second target area to the sintered portion of the first layer of powder, wherein the second region of the second target area is at least partially laterally offset from the second region of the first target area to form the overhanging portion, and wherein sintering the second region of the second target area includes:
   operating the energy beam system in the pulsed mode to generate the second energy beam; and
   directing the second energy beam along a second contour line in the second region of the second target area to deliver one or more of the plurality of pulses to each of a plurality of target locations along the second contour line.
13. The method of any of clauses 11 and 12, further comprising, after sintering the first region of the target area, toggling an energy beam generator in the energy beam system from the continuous wave mode to the pulsed mode.
14. The method of any of clauses 11-13 wherein operating the energy beam system in the continuous wave mode includes powering a first energy beam generator to produce the first energy beam, and wherein operating the energy beam system in the pulsed mode includes powering a second energy beam generator to produce the second energy beam.
15. The method of any of clauses 11-14 wherein operating the energy beam system in the pulsed mode includes operating an energy beam generator at a preset peak power output and a preset duty cycle to deliver the second energy beam to the second region of the target area at a preset average power to control a melt pool in the contour line in the second region of the target area.
16. An additive manufacturing system, comprising:
a build chamber;
a powder deposition system positioned in the build chamber and movable in a lateral direction to deposit a layer of powder over an active build area in the build chamber;
an energy beam system positioned to direct energy beams toward the active build area; and
a controller operably coupled to the energy beam system and having non-transitory machine-readable instructions that, when executed:
   for a first region of a planned build object, operate the energy beam system in a continuous wave mode to:
      generate a first energy beam directed toward the active build area; and
      move the first energy beam along a motion path in the active build area based on a shape of the first region of the planned build object; and
   for a second region of the planned build object, operate the energy beam system in a pulsed mode to:
      generate a second energy beam with a plurality of pulses directed toward the active build area; and
      direct the plurality of pulses of the second energy beam toward the active build area based on a planned exposure pattern for the second region of the planned build object.
17 The additive manufacturing system of clause 16 wherein at least a portion of the planned build object is an overhanging structure, and wherein at least a portion of the second region of the planned build object corresponds to an outer perimeter of the overhanging structure.
18. The additive manufacturing system of any of clauses 16 and 17 wherein the instructions, when executed, further control the energy beam system to generate the second energy beam at a preset peak power, a preset duty cycle, and a preset pulse period to control a melt pool of the layer of powder in the active build area, while operating the energy beam system in the pulsed mode.
19. The additive manufacturing system of clause 18 wherein the preset peak power is between 150 Watts and 250 Watts, wherein the preset duty cycle is between 20 percent and 30 percent, and wherein the preset pulse period is between 12.8 milliseconds and 25.6 milliseconds.
20. The additive manufacturing system of any of clauses 16-19 wherein the layer of powder is a first layer of powder, wherein the plurality of pulses is a first plurality of pulses, wherein the controller is operably coupled to the powder deposition system, and wherein the instructions, when executed:
operate the powder deposition system to deposit a second layer of powder over the first layer of powder;
for the first region of the planned build object:
   operate the energy beam system in the continuous wave mode to generate the first energy beam directed toward the active build area; and
   move the first energy beam along the motion path in the active build area based on the shape of the first region of the planned build object; and
for the second region of the planned build object:
   operate the energy beam system in the pulsed mode to generate the second energy beam with a second plurality of pulses directed toward the active build area; and
   target the second plurality of pulses of the second energy beam toward the active build area based on the planned exposure pattern for the second region of the planned build object.

### Conclusion

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately” and “about” are used herein to mean within at least within 10 10% of a given value or limit. For example, an approximate ratio means within a 10% of the given ratio.

From the foregoing, it will also be appreciated that various modifications may be made without deviating from the disclosure or the technology. For example, although discussed herein primarily in the context of laser beams, one of skill in the art will appreciate that various other energy beams can be used to sinter the powder in each layer of the build object. Furthermore, the energy beam(s) can be used to perform various other functions in the system (e.g., to remove material from layers of the build object rather than sintering powder for new layers of the build object). In another example, the energy beam system can include multiple energy beam generators that are operated simultaneously (or generally simultaneously) to sinter powder via a continuous wave beam and a pulsed beam at the same time. Still further, although the methods are discussed primarily herein in the context of limiting the likelihood of warping and/or collapsing for an overhanging portion, the hybrid sintering processes are not so limited. For example, the hybrid sintering processes can be used for sections of a build object with a relatively low tolerance for error in the surface (e.g., sections requiring precise alignment, sections that will be inaccessible for post-build surface-smoothing operations, and/or the like). In addition, certain aspects of the technology described in the context of particular embodiments may also be combined or eliminated in other embodiments. For example, the controller can be split into multiple controllers each operably coupled to one or more components of the system to perform the actions described herein. In a specific, non-limiting example, the energy beam system can include an individual controller that controls the components of the energy beam system (e.g., the one or more energy beam generators) separate from the operation of the other components of the additive manufacturing system.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. A method for operating an additive manufacturing system to form a build object, the method comprising:
for a first region of a build object, operating an energy beam system in a continuous wave mode to:
generate a first energy beam; and
scan the first energy beam along a motion path in the first region to sinter powder in the first region to a previous layer of the build object; and
for a second region of the build object closer to an edge of the build object than the first region of the build object, operating the energy beam system in a pulsed mode to:
generate a second energy beam; and
direct pulses of the second energy beam toward the second region to sinter powder in the second region to a previous layer of the build object based on a planned exposure pattern.

2. The method of claim 1 wherein the planned exposure pattern includes a plurality of target spots positioned to receive one or more of the pulses of the second energy beam, and wherein an individual of target spot is spaced apart from one or more nearest target spots by a planned distance.

3. The method of claim 2 wherein the second energy beam has a spot profile when incident on the powder in the second region, and wherein the planned distance is less than or equal to a radius of the spot profile.

4. The method of claim 1 wherein the planned exposure pattern includes a plurality of target spots positioned to receive one or more of the pulses of the second energy beam and distributed to expose all of the powder in the second region to at least one pulse of the second energy beam.

5. The method of claim 1 wherein the planned exposure pattern includes at least two lines of a plurality of target spots for the pulses of the second energy beam.

6. The method of claim 1 wherein the energy beam system includes a single energy beam generator, and wherein the method further comprises toggling the single energy beam generator from the continuous wave mode to the pulsed mode between operating on the first region and the operating on second region.

7. The method of claim 1 wherein, in the pulsed mode, the second energy beam has a pulse period between 12.8 microseconds (ms) and 25.6 ms and a pulse width between 3.2 ms and 6.4 ms.

8. The method of claim 1 wherein the build object includes a plurality of layers, wherein the first region and the second region are on individual one of the plurality of layers, and wherein the method further comprises, for each other individual layer in the plurality of layers:
for a central region of the other individual layer, operating the energy beam system in the continuous wave mode to sinter powder in the central region; and
for a peripheral region of the other individual layer, operating the energy beam system in the pulsed mode to sinter powder in the peripheral region,
wherein each layer in the plurality of layers has a footprint that is at least partially offset from a previous layer to form an overhanging portion of the build object.

9. The method of claim 8 wherein each layer in the plurality of layers is sintered without forming a support structure to support the overhanging portion or removing material from an exterior surface of the overhanging portion after sintering the plurality of layers.

10. The method of claim 1 wherein the energy beam system includes a first energy beam generator configured to generate the first energy beam and a second energy beam generator configured to generate the second energy beam.

11. A method for operating an additive manufacturing system to form an overhanging portion of a build object, the method comprising:
depositing a layer of powder over an active build area within a build chamber of the additive manufacturing system;
sintering a first region of a target area of the layer of powder to a previous layer of the build object, wherein sintering the first region of the target area includes:
operating an energy beam system in a continuous wave mode to generate a first energy beam having a continuous output; and
directing the first energy beam along one or more scan lines in the first region; and
sintering a second region of the target area to the previous layer of the build object, wherein the second region of the target area is closer to an edge of the overhanging portion than the first region, and wherein sintering the second region of the target area includes:
operating the energy beam system in a pulsed mode to generate a second energy beam having a plurality of pulses; and
directing the second energy beam along a contour line in the second region to deliver one or more of the plurality of pulses to each of a plurality of target locations along the contour line.

12. The method of claim 11 wherein the layer of powder is a first layer of powder, wherein the target area is a first target area, wherein the one or more scan lines are one or more first scan lines, wherein the contour line is a first contour line, and wherein the method further comprises:
depositing a second layer of powder over the active build area of the build chamber;
sintering a first region of a second target area of the second layer of powder to a sintered portion of the first layer of powder, wherein the first region of the second target area is at least partially laterally offset from the first region of the first target area to form the overhanging portion, and wherein sintering the first region of the second target area includes:
operating the energy beam system in the continuous wave mode to generate the first energy beam; and
directing the first energy beam along one or more second scan lines in the first region of the second target area; and
sintering a second region of the second target area to the sintered portion of the first layer of powder, wherein the second region of the second target area is at least partially laterally offset from the second region of the first target area to form the overhanging portion, and wherein sintering the second region of the second target area includes:
operating the energy beam system in the pulsed mode to generate the second energy beam; and
directing the second energy beam along a second contour line in the second region of the second target area to deliver one or more of the plurality of pulses to each of a plurality of target locations along the second contour line.

13. The method of claim 11, further comprising, after sintering the first region of the target area, toggling an energy beam generator in the energy beam system from the continuous wave mode to the pulsed mode.

14. The method of claim 11 wherein operating the energy beam system in the continuous wave mode includes powering a first energy beam generator to produce the first energy beam, and wherein operating the energy beam system in the pulsed mode includes powering a second energy beam generator to produce the second energy beam.

15. The method of claim 11 wherein operating the energy beam system in the pulsed mode includes operating an energy beam generator at a preset peak power output and a preset duty cycle to deliver the second energy beam to the second region of the target area at a preset average power to control a melt pool in the contour line in the second region of the target area.

16. An additive manufacturing system, comprising:
a build chamber;
a powder deposition system positioned in the build chamber and movable in a lateral direction to deposit a layer of powder over an active build area in the build chamber;
an energy beam system positioned to direct energy beams toward the active build area; and
a controller operably coupled to the energy beam system and having non-transitory machine-readable instructions that, when executed:
for a first region of a planned build object, operate the energy beam system in a continuous wave mode to:
generate a first energy beam directed toward the active build area; and
move the first energy beam along a motion path in the active build area based on a shape of the first region of the planned build object; and
for a second region of the planned build object, operate the energy beam system in a pulsed mode to:
generate a second energy beam with a plurality of pulses directed toward the active build area; and
direct the plurality of pulses of the second energy beam toward the active build area based on a planned exposure pattern for the second region of the planned build object.

17. The additive manufacturing system of claim 16 wherein at least a portion of the planned build object is an overhanging structure, and wherein at least a portion of the second region of the planned build object corresponds to an outer perimeter of the overhanging structure.

18. The additive manufacturing system of claim 16 wherein the instructions, when executed, further control the energy beam system to generate the second energy beam at a preset peak power, a preset duty cycle, and a preset pulse period to control a melt pool of the layer of powder in the active build area, while operating the energy beam system in the pulsed mode.

19. The additive manufacturing system of claim 18 wherein the preset peak power is between 150 Watts and 250 Watts, wherein the preset duty cycle is between 20 percent and 30 percent, and wherein the preset pulse period is between 12.8 milliseconds and 25.6 milliseconds.

20. The additive manufacturing system of claim 16 wherein the layer of powder is a first layer of powder, wherein the plurality of pulses is a first plurality of pulses, wherein the controller is operably coupled to the powder deposition system, and wherein the instructions, when executed:
operate the powder deposition system to deposit a second layer of powder over the first layer of powder;
for the first region of the planned build object:
operate the energy beam system in the continuous wave mode to generate the first energy beam directed toward the active build area; and
move the first energy beam along the motion path in the active build area based on the shape of the first region of the planned build object; and
for the second region of the planned build object:
operate the energy beam system in the pulsed mode to generate the second energy beam with a second plurality of pulses directed toward the active build area; and
target the second plurality of pulses of the second energy beam toward the active build area based on the planned exposure pattern for the second region of the planned build object.
